(19) United States
(12) Patent Application Publication
(10) Pub. No.: US 2012/0250145 A1
(43) Pub. Date: Oct. 4, 2012

(54) Magnification device and assembly

(76) Inventors: Richard E. Feinbloom, New York, NY (US); Kenneth Braganca, Ronkonkoma, NY (US)

(21) Appl. No.: 13/065,809

(22) Filed: Mar. 30, 2011

(51) Int. Cl. G02B 25/00

(52) U.S. Cl. 359/361; 359/722; 359/350; 359/481

(57) ABSTRACT

A magnification device including: a housing including a distal open end and a proximal open end; an optical system including one or more objective lenses mounted in the housing adjacent the distal open end, and one or more eye lenses mounted in the housing adjacent the proximal open end; and a filtering system suitable for attenuating selected wavelengths from the transmission of electromagnetic radiation including a first filter lens mounted to the distal open end of the housing adjacent the one or more objective lenses, and a second filter lens mounted to the proximal open end adjacent the one or more eye lenses, the first filter lens closing the distal open end of said housing is provided. A vision enhancing assembly including a carrier device and one or more magnification devices coupled to the carrier device is also provided.

### BACKGROUND OF THE INVENTION

1. Field of the Invention

The invention relates generally to optical devices, and more particularly, to optical magnification devices for use in the presence of a source of electromagnetic radiation.

2. Background Information

Lasers have found utility in a number of applications, including, for example, communications, energy production, electronics, cosmetology, dermatology, medicine, and dentistry. Light (or electromagnetic radiation) emitted from a laser, predominantly by stimulated emission, is extremely intense, coherent, monochromatic, and highly collimated. When a laser is used, for example, during a medical or dental procedure, the surgeon or dentist must wear an eye protection device, for example, laser safety glasses, to avoid damage to the eye, as the beam produced by the laser can cause significant damage to the eye.

In addition to lasers, magnification devices may be also used, for example, by surgeons and dentists during medical or dental procedures, for magnifying a work area requiring precision. The magnification devices used may include telescopes, microscopes, endoscopes, and eye-loupes.

Exposure to laser beams in the visible (400 nm to 700 nm) and near-infrared (700 nm to 1400 nm) regions of the spectrum (retinal hazard region) may damage the retina, particularly when viewed through magnifying optical devices, as the energy concentration of a laser beam may increase up to one million times. Although infrared lasers (1.400 μm to 1 mm) and ultraviolet lasers 0.180 μm to 0.400 μm) do not present a retinal hazard, damage to the eye can still occur.

Currently available laser safety glasses or goggles filter out the wavelength or wavelengths emitted by the laser, with the goal of providing maximum visible light transmission (VLT). To filter out the wavelength, chemical additives or dyes may be added to a filter (in the form of a lens), which may be formed of polycarbonate, glass, or other suitable material, to match and consequently absorb the wavelength and power of the source of laser radiation. In addition to absorptive, reflective filters may also be used.

Depending upon the laser and the application, the attenuation or optical density, D_{λ}, (OD) of the filter lens at a specific wavelength should be specified. Since lasers may radiate at more than one wavelength, eyewear designed to have an adequate OD of a particular wavelength may have an inadequate OD at another wavelength for light emitted by the same laser. Most eye protection glasses or goggles use selective wavelength attenuation to protect eyes from harmful laser radiation while permitting the eyes to see something of interest, by filtering radiation inside and outside the visible range, yet many of the currently-available devices are cumbersome or uncomfortable when used in conjunction with an optical magnifying device.

Accordingly, there remains a need for optical magnification devices suitable for use in the presence of a radiation-emitting source to protect the eyes of a user.

### SUMMARY OF THE INVENTION

Briefly described, according to an aspect of the invention, a magnification device includes a housing including a distal open end and a proximal open end; an optical system including one or more objective lenses mounted in the housing adjacent the distal open end, and one or more eye lenses mounted in the housing adjacent the proximal open end; and a filtering system suitable for attenuating selected wavelengths from the transmission of electromagnetic radiation including a first filter lens mounted to the distal open end of the housing adjacent the one or more objective lenses, and a second filter lens mounted to the proximal open end adjacent the one or more eye lenses, the first filter lens closing the distal open end of said housing.

According to another aspect of the invention, a vision enhancing assembly includes a carrier device; one or more magnification devices coupled to the carrier device, each of the magnification devices including: a housing including a distal open end and a proximal open end; an optical system including one or more objective lenses mounted in the housing adjacent the distal open end, and one or more eye lenses mounted in the housing adjacent the proximal open end; and a filtering system suitable for attenuating selected wavelengths from the transmission of electromagnetic radiation including an external filter lens mounted to the distal open end of the housing, and an internal filter lens mounted to the proximal open end, the exterior filter lens closing the distal open end of the housing.

### BRIEF DESCRIPTION OF THE DRAWINGS

FIG. 1 is an exploded perspective view of a magnification device according to an aspect of the invention;

FIG. 2 is a cross-sectional, assembled view of the device illustrated in FIG. 1;

FIG. 3 is an exploded perspective view of a magnification device according to an aspect of the invention;

FIG. 4 is a cross-sectional, assembled view of the device illustrated in FIG. 3;

FIG. 5 is an exploded perspective view of a magnification device according to another aspect of the invention;

FIG. 6 is a cross-sectional view of the device illustrated in FIG. 5;

FIG. 7 is an exploded view of a prism assembly illustrated in FIG. 5;

FIG. 8 is a front elevational view of an assembly illustrating magnification devices in a carrier device; and

FIG. 9 is a rear elevational view of the assembly illustrated in FIG. 8.

### DETAILED DESCRIPTION OF THE INVENTION

As used herein, the terms “comprises”, “comprising”, “includes”, “including”, “has”, “having”, or any other variation thereof, are intended to cover non-exclusive inclusions. For example, a process, method, article or apparatus that comprises a list of elements is not necessarily limited to only those elements but may include other elements not expressly listed or inherent to such process, method, article, or apparatus. In addition, unless expressly stated to the contrary, the term “of” refers to an inclusive “or” and not to an exclusive “or”. For example, a condition A or B is satisfied by any one of the following: A is true (or present) and B is false (or not present); A is false (or not present) and B is true (or present); and both A and B are true (or present).

The terms “a” or “an” as used herein are to describe elements and components of the invention. This is done for convenience to the reader and to provide a general sense of the invention. The use of these terms in the description herein should be read and understood to include one or at least one. In addition, the singular also includes the plural unless indicated to the contrary. For example, reference to a composition containing “a compound” includes one or more compounds. As used in this specification and the appended claims, the term “or” is generally employed in its sense including “and/or” unless the content clearly dictates otherwise.

All numeric values are herein assumed to be modified by the term “about,” whether or not explicitly indicated. The term “about” generally refers to a range of numbers that one of skill in the art would consider equivalent to the recited value (i.e., having the same function or result). In any instances, the terms “about” may include numbers that are rounded to the nearest significant figure.

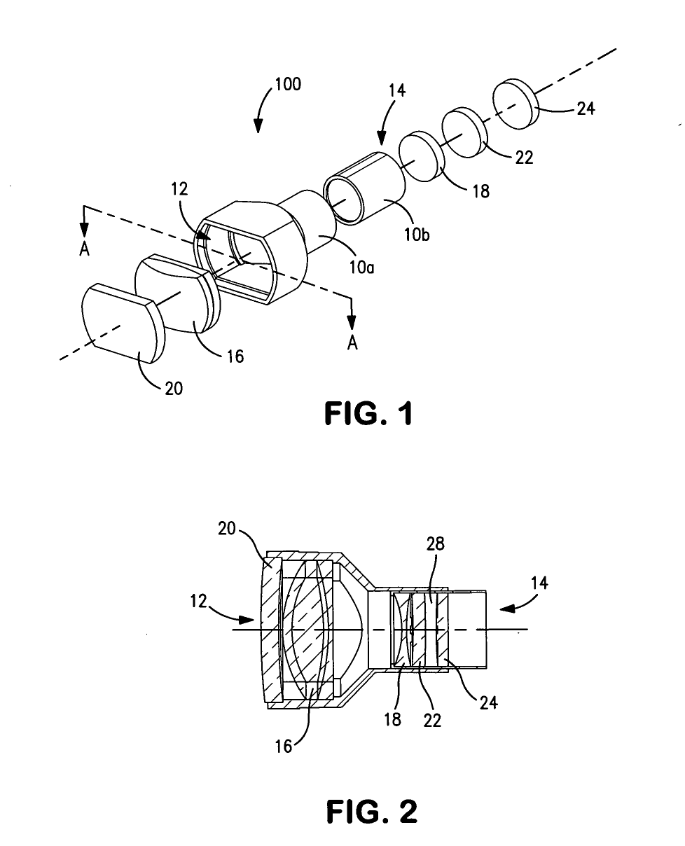

Referring to FIG. 1, a magnification device 100 according to an aspect of the invention is illustrated. Separate housing portions 10a and 10b are provided to allow for the precise placement of the objective lens(es) 16 and the eye lens(es) 18 prior to assembly. The housing portions 10a and 10b are formed of a relatively rigid and lightweight plastic material. Housing portion 10a includes a Galilean optical system with one or more objective lenses 16 mounted in housing 10a adjacent the distal open end 12. The objective lens(es) 16 may include, but are not limited to, convex, biconvex, plus convex, doublet plano-convex, doublet bi-convex, double convex crown and concave flint, and other suitable precision magnification lenses.

According to an aspect of the invention, there may be one, two, or three objective lenses 16 present. The device 100 illustrated in FIG. 1 includes two lenses that are coupled together to form the objective lens 16. The resulting achromat lens 16 minimizes chromatic aberration. According to an aspect of the invention, the objective lens(es) 16 may be substantially rectangular. When a rectangular objective lens 16 is employed, a wider field of view is obtained, as more light is allowed to enter the device. According to another aspect of the invention, the objective lens(es) 16 may be substantially circular.

Still referring to FIG. 1, the Galilean optical system further includes one or more eye lenses 18 mounted in housing portion 10b adjacent the proximal end 14 thereof. The eye lens(es) 18 may include, but are not limited to, concave, bi-concave, plano-concave, negative, diverging, and other suitable precision magnification lenses. According to an aspect of the invention, the eye lens(es) 18 may be bi-concave, or negative.

The magnification device 100 illustrated in the exploded view of FIG. 1 is shown assembled in FIG. 2. As needed, a lens 24 for spectacle correction may be present in the device 10 and mounted in housing portion 10b adjacent the proximal end 14. To the extent a spectacle correction lens is unnecessary, the lens 24 is plano. Regardless of which type of lens 24 is included in the device 100, the spectacle correction or plano lens closes the proximal end 14 of the housing portion 10b. Lenses 16, 18, and 24 and filter 22 are mounted in the housing with an epoxy or other suitable adhesive.

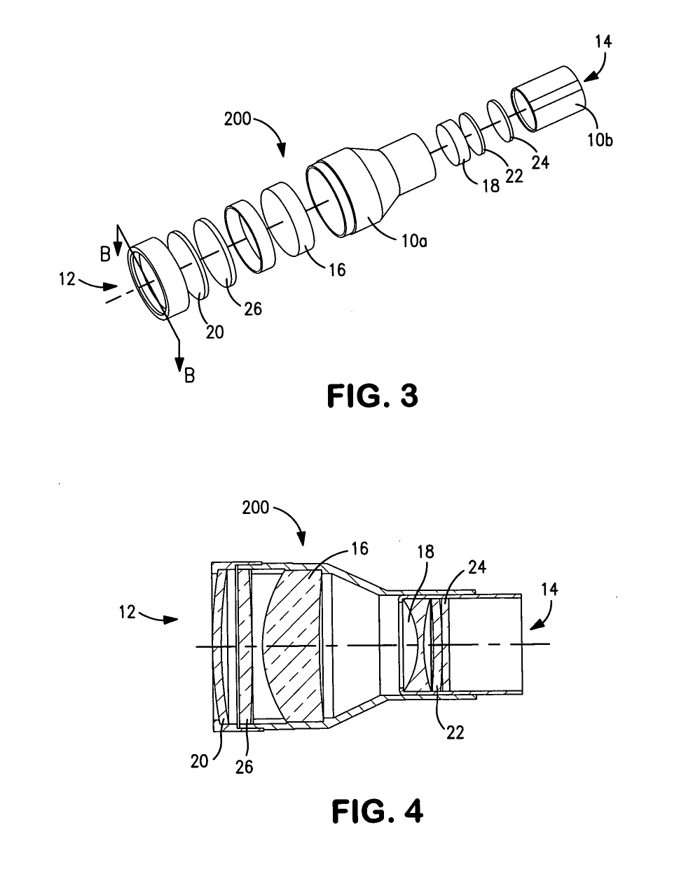

Referring to FIG. 3, a magnification device 200 according to an aspect of the invention is illustrated. In this aspect, a working distance lens 26 is included in the device 200, which is further illustrated in an assembled state, in the cross-sectional view of FIG. 4, taken along lines B-B of FIG. 3.

Lenses having magnification, i.e., collecting optics, produce an increase in energy or power density, as the beam diameter is reduced by the magnifying power of the optics, which, when viewing a laser beam through the lenses, may increase and result in hazardous exposure conditions to the eye. Although some laser systems are incapable of producing hazardous exposure conditions during normal operation, when viewing a beam through an optical instrument, for example, an eye-loupe, the hazards may be increased. In the optical systems of the magnification devices described herein, which collect light through the objective lens(es) 16 and eye lens(es) 18, the hazards from lasers are magnified, and can easily damage a person's vision since the cornea and lens focus the laser energy onto the retina. When viewing the laser from within the beam (intrabeam viewing) the hazard may be increased by as much as the square of the magnifying power of the optical magnification device.

Advantageously, the filtering system according to the invention blocks or filters the harmful transmission of electromagnetic radiation prior to becoming collected and increased by the optical system, and prior to entering the objective lens(es) 16, while being transparent to maximize visible light transmission. The filtering system, as illustrated in FIG. 1, includes an exterior first filter lens 20 mounted to the distal open end 12 of the housing 10a. The exterior filter lens 20 closes the distal open end 12 of the housing 10a. The exterior filter lens 20 advantageously attenuates the electromagnetic radiation to a safe level, but some radiation is still transmitted through the device. As the remnants of radiation are transmitted through the optical system, the remnants are magnified to a level that may become dangerous. To attenuate the remaining radiation that has become magnified by passing through the optical system, the filtering system also includes a second filter lens 22 mounted adjacent to the proximal open end 14 of housing 10b. The second filter lens 22 of the filtering system is provided in the interior of the housing 10b to eliminate any possibility of harmful radiation reaching the user's eyes through any of the lenses (objective or eye lens(es)) of the magnification device.

The type of filters suitable for use according to the invention depend upon the radiation-emitting device being used during a procedure. For example, to prevent damage from a laser transmitting beams at wavelengths ranging between about 2600 to about 3000 nm would require a filtering system that blocks wavelengths in the above-described range. There are many different types of lasers available on the market suitable for use, some of which are capable of emitting more than one wavelength. Examples of lasers include, but are not limited to: argon fluoride, xenon chloride, xenon fluoride, helium cadmium, argon, excimer, erbium:yttrium-aluminum-garnet (Er:YAG), neodymium:yttrium-aluminum-garnet (Nd:YAG), erbium:chromium:yttrium-scandium-gallium-garnet (ER:CR:YSGG), laser diodes, titanium-sapphire, ruby, alexandrite, erbium, hydrogen fluoride, and carbon monoxide and dioxide.

Depending upon the laser used, the application, and the manner in which the laser is used, a protection factor, i.e., the Optical Density (OD), is calculated with respect to the filter(s). The higher the OD factor, the higher the attenuation. Filters suitable for use according to the invention are available from NoIR Laser Company, L.L.C. of South Lyon, Mich. The filters 20 and 22 may suitably be formed of polycarbonate.

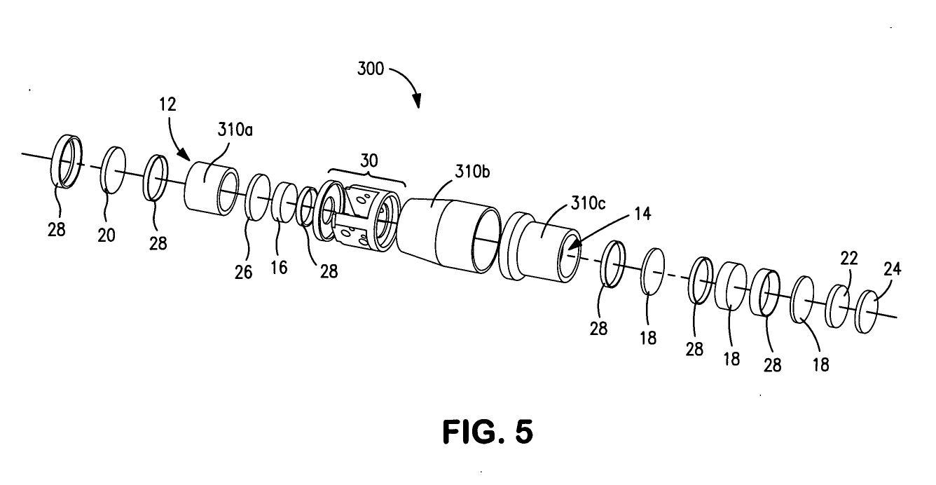

FIG. 5 illustrates a magnification device 300 according to another aspect of the invention. In this aspect, a Keplerian optical system is employed to provide a wider field of view than the Galilean system, which has a relatively small field of view. The Galilean system, however, is lighter in weight than the Keplerian. The housing for the optical and filtering system includes three separate housing portions, 310a, 310b and 310c. The three housing portions are provided to allow for the precise placement of the objective lens(es) 16, the prism assembly 30, and the eye lens(es) 18 prior to assembly.

As with devices 100 and 200, the filtering system includes an exterior filter lens 20 mounted to the distal open end 12 of the housing 310a. The filter lens 20 closes the distal open end 12 of the housing 310a. The filtering system also includes a second filter lens 22 mounted adjacent to the proximal open end 14 of housing 310c. A prescription or plano lens 24 is mounted to and closes the proximal open end 14 of housing portion 310c. As described above, the second filter lens 22 is provided to ensure that no harmful radiation reaches the user's eyes through any of the lenses (objective or eye lens(es)) of the magnification device.

In this aspect, spacers 28 are used to separate the various lenses 16 and 18. For example, a spacer 28 is illustrated in FIG. 5 between the housing 310a and the exterior filter lens 20. Additional spacers 28 are illustrated between the eye lenses 18. The spacers 28, which may suitably be formed of plastic, provide for proper placement and retention of the lenses 16, 18 and 20 within the housing portion 310a and housing portion 310c. A working distance lens 26 may also be present in the device.

In the Keplerian optical system, the one or more objective lenses 16 may be substantially circular, or could be rectangular, and may include, but are not limited to, convex, biconvex, plus convex, doublet plano-convex, doublet bi-convex, and other suitable precision magnification lenses. The device 300 illustrated in FIG. 5 includes three eye lenses 18. In this aspect of the invention, one or more of the eye lenses 18 are positive, convex, or bi-convex.

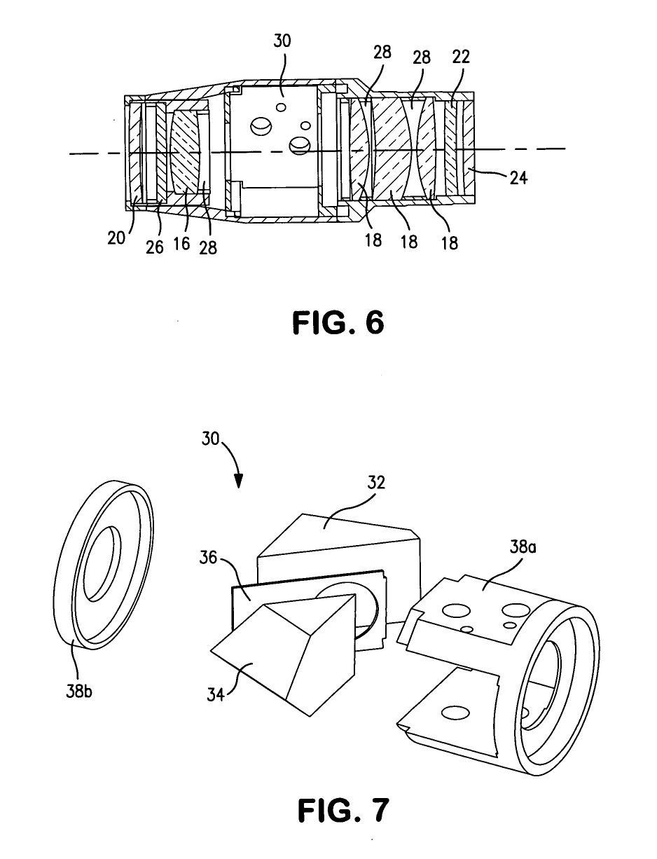

The device 300 of FIG. 5 is illustrated in FIG. 6 in an assembled state. The prism assembly 30 illustrated in FIG. 5 is illustrated in further detail in FIG. 7. In FIG. 7, the prism assembly 30 includes an Amici prism 32 and a Schmidt prism 34, separated by a divider 36, and disposed in a housing 38a and 38b. The apertures formed in the housing 38a and 38b and in the divider 36 allow for the passage of light. Since the Keplerian optics employed in this aspect of the invention inverts the orientation of a viewed image or object, the prism assembly 30 is provided to invert the viewed object so that it appears in the correct context to preserve the field of view.

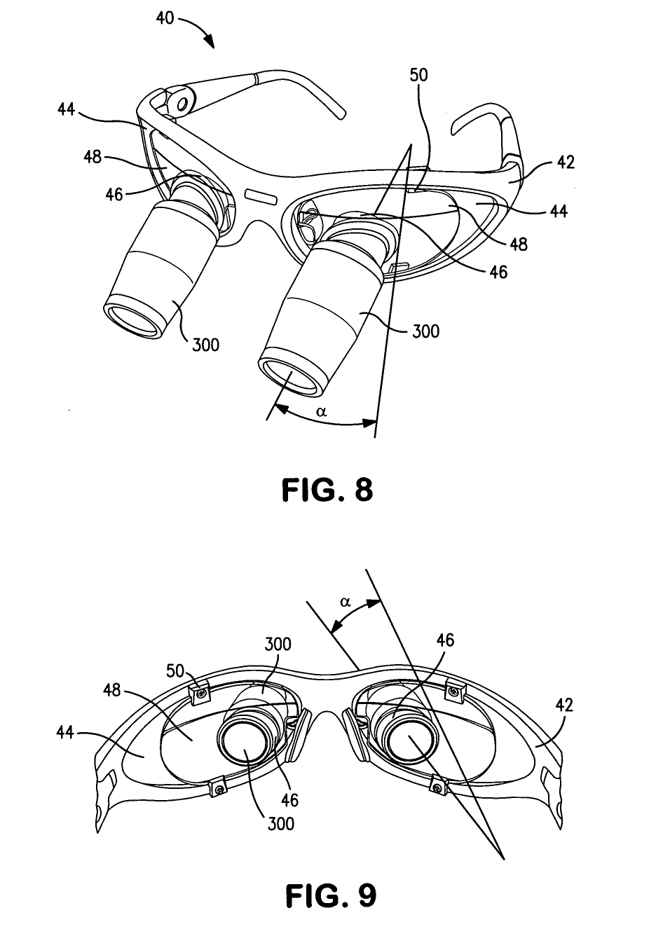

Referring now to FIGS. 8 and 9, magnification devices or loupes according to an aspect of the invention are illustrated as being disposed in a carrier device 40 to provide binocular vision to a user. The carrier device 40 in this aspect is a spectacle or an eyeglass frame 42 with carrier lenses 44. Alternative carrier devices 40 may include headbands, goggles, visors, or other devices suitable for supporting the magnifying devices to provide binocular vision. The carrier lenses 44 each include an aperture 46 through which the magnification devices 100, 200, or 300 are mounted. The carrier lenses 44 may be plano or prescription, and are configured for preventing the harmful transmission of radiation as with filter lenses 20 and 22. Additional supporting carrier lenses 48 may be secured to the spectacle frame 42 by a clip 50 or other conventional means. Although a Keplerian assembly according to an aspect of the invention is illustrated in FIGS. 8 and 9, it should be understood that a Galilean assembly may also be mounted on a spectacle frame 42 or other suitable carrier devices 40 as described above.

As illustrated in FIGS. 8 and 9, the magnification devices are positioned in the carrier lenses at a selected angle of declination to provide a user with ease of use, and to promote proper posture for the back, neck, head, and eyes that may be assumed when working at a close distance.

According to an aspect of the invention, the filtering system attenuates wavelengths from a radiation-emitting source, for example, a laser, in the range of about 190 to about 400 nm. In another aspect, the filtering system attenuates wavelengths in the range of about 730 nm to about 760 nm, in the range of about 785 nm to about 1090 nm, and in the range of about 2700 nm to about 2950 nm. According to another aspect of the invention, the filtering system attenuates wavelengths at about 10600 nm. It should be understood that additional wavelengths may be filtered, as the above ranges of wavelengths is not meant to be exhaustive.

Advantageously, the magnification devices according to the invention block or attenuate harmful wavelengths of radiation, including laser light, whether visible or invisible, and provide magnification at 2.5×, 3.5×, 4.5×, and 6.0×. It should be understood that other magnifications may also be provided.

The invention has been described with reference to specific embodiments. One of ordinary skill in the art, however, appreciates that various modifications and changes can be made without departing from the scope of the invention as set forth in the claims. Accordingly, the specification is to be regarded in an illustrative manner, rather than with a restrictive view, and all such modifications are intended to be included within the scope of the invention.

Benefits, other advantages, and solutions to problems have been described above with regard to specific embodiments. The benefits, advantages, and solutions to problems, and any element(s) that may cause any benefits, advantages, or solutions to occur or become more pronounced, are not to be construed as a critical, required, or an essential feature or element of any or all of the claims.

What is claimed is:

1. A magnification device, comprising:
a housing comprising a distal open end and a proximal open end;
an optical system comprising one or more objective lenses mounted in said housing adjacent said distal open end, and one or more eye lenses mounted in said housing adjacent said proximal open end; and
a filtering system suitable for attenuating selected wavelengths from the transmission of electromagnetic radiation comprising a first filter lens mounted to said distal open end of said housing adjacent said one or more objective lenses, and a second filter lens mounted to said proximal open end adjacent said one or more eye lenses, said first filter lens closing said distal open end of said housing.

2. The magnification device according to claim 1, wherein at least one of said one or more objective lenses is convex.

3. The magnification device according to claim 1, wherein at least one of said objective lenses is substantially rectangular.

4. The magnification device according to claim 1, wherein at least one of said objective lenses is substantially circular.

5. The magnification device according to claim 1, wherein said optical system is Galilean.

6. The magnification device according to claim 1, wherein said optical system is Keplerian.

7. The magnification device according to claim 5, wherein at least one of said one or more eye lenses are concave or negative.

8. The magnification device according to claim 6, wherein at least one of said one or more eye lenses are convex or plus.

10. The magnification device according to claim 1, wherein said optical system further comprises a spectacle correction lens mounted in said housing adjacent said proximal open end.

11. The magnification device according to claim 1, wherein said filtering system attenuates wavelengths from a laser source in the range of about 190 nm to about 400 nm.

12. The magnification device according to claim 1, wherein said filtering system attenuates wavelengths from a laser source at about 730 nm to about 760 nm.

13. The magnification device according to claim 1, wherein said filtering system attenuates wavelengths from a laser source in the range of about 785 nm to about 1090 nm.

14. The magnification device according to claim 1, wherein said filtering system attenuates wavelengths from a laser source in the range of about 2700 nm to about 2950 nm.

15. The magnification device according to claim 1, wherein said filtering system attenuates wavelengths from a laser source at about 10600 nm.

16. A vision enhancing assembly, comprising:
a carrier device;
one or more magnification devices coupled to the carrier device, each of said magnification devices comprising:
a housing comprising a distal open end and a proximal open end;
an optical system comprising one or more objective lenses mounted in said housing adjacent said distal open end, and one or more eye lenses mounted in said housing adjacent said proximal open end; and
a filtering system suitable for attenuating selected wavelengths from the transmission of electromagnetic radiation comprising an external filter lens mounted to said distal open end of said housing, and an internal filter lens mounted to said proximal open end, said exterior filter lens closing said distal open end of said housing.

17. The vision enhancing assembly according to claim 16, wherein said carrier device is an eyeglass frame with carrier lenses.

18. The vision enhancing assembly according to claim 16, wherein at least one of said one or more objective lenses is convex.

19. The vision enhancing assembly according to claim 16, wherein at least one of said one or more objective lenses is substantially rectangular.

20. The vision enhancing assembly according to claim 16, wherein at least one of said one or more objective lenses is substantially circular.

21. The vision enhancing assembly according to claim 16, wherein said optical system is Galilean.

22. The vision enhancing assembly according to claim 16, wherein said optical system is Keplerian.

23. The vision enhancing assembly according to claim 21, wherein at least one of said one or more eye lenses is concave or negative.

24. The vision enhancing assembly according to claim 22, wherein at least one of said one or more eye lenses is convex or plus.

25. The vision enhancing assembly according to claim 16, wherein said optical system further comprises a spectacle correction lens mounted in said housing adjacent said proximal open end.
